(19) United States
(12) Patent Application Publication
(10) Pub. No.: US 2010/0187959 A1
(43) Pub. Date: Jul. 29, 2010

(54) IMPACT-RESISTANT FURNITURE ITEM AND A METHOD FOR ITS MANUFACTURE

(75) Inventor: Emo Agneloni, San Mariano (IT)

Correspondence Address: YOUNG & THOMPSON, 209 Madison Street, Suite 500, Alexandria, VA, 22314, US

(73) Assignee: TEC.INN, S.R.L., SAN MARIANO (PG) (IT)

(21) Appl. No.: 12/602,105

(22) PCT Filed: May 22, 2008
(86) PCT No.: PCT/IT2008/000341

§ 371 Date: Nov. 27, 2009

(30) Foreign Application Priority Data
May 28, 2007 (IT) RM2007A000290

(51) Int. Cl. A47B 81/00; A47B 97/00; A47B 96/00; B23P 17/04

(52) U.S. Cl. 312/239; 312/352; 312/351.1; 29/428

(57) ABSTRACT

An impact-resistant furniture item includes a load-bearing structure (2), having a support function for the furniture item (1), and an elastic layer (11) associated to the load-bearing structure and co-operating therewith to achieve an absorption and/or a dissipation of energy following deformations of the furniture item. The elastic layer is superposed to an inner surface of the load-bearing structure and it is at least partially uncoupled therefrom so that the elastic layer can be deformed and slide relative to the load-bearing structure. A method for manufacturing the furniture item includes the steps of readying the load-bearing structure, readying anchoring element (16) on the load-bearing structure, and applying an elastic layer of polyurea on at least one inner surface (12) of the load-bearing structure, preferably by spraying, so that the applied polyurea is also laid on the anchoring element (16) and remains stably connected to the load-bearing structure by effect of the anchoring element.

### TECHNICAL FIELD

The present invention relates to a furniture item, or a furnishing element, that is resistant to impacts and in particular to impulsive impacts. Preferably, the furniture item according to the invention is able to define a space to house at least one part of a user, and in particular the legs. By way of example, said furniture item can be a stall or a writing desk.

The invention also relates to a method to manufacture said furniture item. In particular, said method is aimed at manufacturing a furniture item that is able to dissipate energy in case of impact against the furniture item itself, and that is also able to remain stably anchored to the floor during said impact.

### BACKGROUND ART

Known furniture items, such as stalls or desks, are manufactured using wooden panels (solid wood, plywood, chipboard and the like) which are mutually connected, generally at right angles, to define a rigid structure presenting a horizontal work counter.

In the prior art, it is also known to reinforce said furniture items by using bars or section bars made of metal, and in particular steel, anchored to the wooden panels to stiffen the structure of the furniture item making it able to withstand larger loads than the rigid wooden structure alone would be able to withstand. This generally takes place in desks to be used in schools, in which the metal section bars aid the work counter in the resistance action and also embody the legs of the desk itself.

These types of furniture items made of wood and/or reinforced with metal section bars are not, however, able to withstand violent and impulsive impacts or loads such as, in particular, impacts derived from the fall or collapse of portions of structural elements of a building in which said furniture item is situated. Consider, for example, a desk or a writing desk for school use subjected to the impact with a portion of ceiling or of a masonry wall. As a result of a structural collapse, the fall of said portion of ceiling or of masonry wall would cause the desk to give way rapidly, and the metal section bar would not in fact be able to provide an effective increase in resistance against its giving way.

More in detail, statistically likely impacts may be of the distributed or punching type. Distributed impacts cause an overload substantially on the entire work counter, and cause a structural collapse of the desk whose legs tend to diverge from each other, causing the desk to be crushed. Punching impacts cause overloads concentrated on a limited portion of the work counter, and may cause a perforation of the work counter without any valid opposition to said punching action by the desk. In both cases, moreover, the rupture of the wooden parts (and possibly also of the metal parts) triggers a production of splinters which may be very sharp, and hence cause even severe injuries to the user, and they act simultaneously with the impacting action that causes the collapse of the desk or of a portion thereof.

In both circumstances, the desk does not provide a valid protection against injuries that are very likely to be highly severe and thus the desk cannot be used in any way as a shelter following a catastrophic event, such as an earthquake. Lack of resistance to impacts, or lack of resilience, of prior art furniture items are therefore due to a poor structural resistance performance, to the presence of the work counter alone as an element of interposition between the user and the impacting action, and to the collapse mode which is of the fragile type with the production of sharp splinters and, therefore, highly dangerous.

### DISCLOSURE OF INVENTION

A technical task of the present invention is to make available an impact-resistant furniture item, and a method to manufacture said furniture item, that are free of the aforementioned drawbacks.

Within said technical task, a primary object of the invention is to make available an impact-resistant furniture item that allows to obtain a space suitable to define a protection cell by a user in the case of dangerous events.

More in detail, an object of the invention is to make available an impact-resistant furniture item, and a method to manufacture said furniture item, which reduce the risks of fragile collapse of the furniture item itself. Moreover, an important object of the invention is to make available an impact-resistant furniture item, and a method to manufacture said furniture item, which prevent risks for the user, linked to the production of splinters and/or sharp fragments in case of a dangerous event.

An important object of the invention is also to make available an impact-resistant furniture item, and a method to manufacture said furniture item, which generate a sufficient interposition action between an impacting body and a portion of space subtended by the furniture item itself.

Another important object of the invention is to make available an impact-resistant furniture item, and a method to manufacture said furniture item, which enable to perform a protective action against both distributed and punching impacts.

These objects and others besides, as shall become readily apparent hereafter in the present description, are substantially achieved by an impact-resistant furniture item and a method to manufacture said furniture item having the characteristics respectively expressed in claims 1 and 13 and/or in one or more of the claims that depend thereon.

### DESCRIPTION OF THE DRAWINGS

By way of non limiting example, a preferred but non exclusive embodiment of an impact-resistant furniture item, and a method to manufacture said furniture item, is illustrated below, in accordance with the present invention and with the accompanying figures, in which:

FIG. 1 shows a perspective view of a furniture item in accordance with the present invention;

FIG. 2 shows a front view of the furniture item of FIG. 1;

FIG. 2a shows an enlarged front view of a first detail of the view of FIG. 25;

FIG. 2b shows an enlarged front view of a second detail of the view of FIG. 2;

FIG. 2c shows an enlarged front view of a third detail of the view of FIG. 2;

FIG. 3 shows an exploded view of a portion of the furniture item of FIG. 1;

FIG. 4 shows a front view of the furniture item of FIG. 2 in a first deformed configuration;

FIG. 5 shows a front view of the furniture item of FIG. 2 in a second deformed configuration.

### DESCRIPTION OF THE ILLUSTRATIVE EMBODIMENT

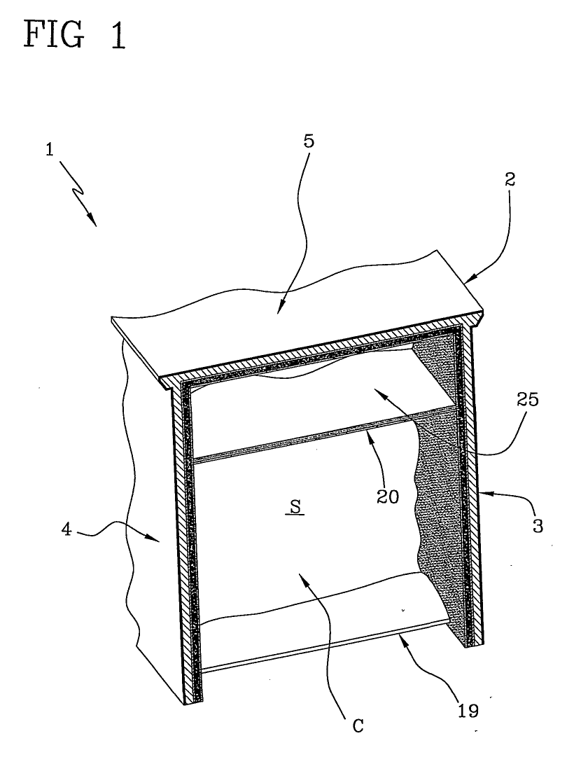

In FIG. 1, the reference number 1 designates in its entirety an impact-resistant furniture item in accordance with the present invention. Within the present description, reference will be made, as a furniture item 1 according to the invention, to a desk for school use; nevertheless, while the application as a desk for school use is particularly advantageous, said specific application does not constitute a limitation, because the present invention can be extended to any type of furniture item such as, by way of example, a writing desk, a table, a cabinet or a bridge bookcase or a generic furniture item able to define a shelter for one or more persons in case of a dangerous event.

The desk comprises a load-bearing structure 2 which is defined by a pair lateral walls 3, 4 joined through a central portion 5. The central portion 5 defines a support plane and/or work counter for the desk, and it is therefore placed in substantially horizontal position, whilst the lateral walls 3, 4 are placed according to a substantially vertical orientation. According to a preferred embodiment, not illustrated, the lateral walls 3, 4 are divergent, preferably only slightly, away from the central portion 5. The load-bearing structure 2 is obtained, preferably in a single step, through a process called “Resin Transfer Moulding” {RTM). The lateral walls 3, 4, defining support uprights for the load-bearing structure 2, and the central portion 5, delimit between them a space “S” in which can be housed a part of the user during a normal use of the furniture item, and in particular the part of the user's legs with reference to the desk for school use. Preferably, the lateral walls 3, 4 and the central portion 5 do not present through openings for reasons that shall be clarified hereafter. Advantageously, the lateral walls 3, 4 and the central portion 5 are obtained in a single piece with each other. In other words, there is a structural continuity between each lateral wall 3, 4, the central portion 5 and the other lateral wall 3, 4 so that there are no junctions in the passage between them. This determines an increase in the total strength of the load-bearing structure 2 that makes it better able to withstand even violent impacts.

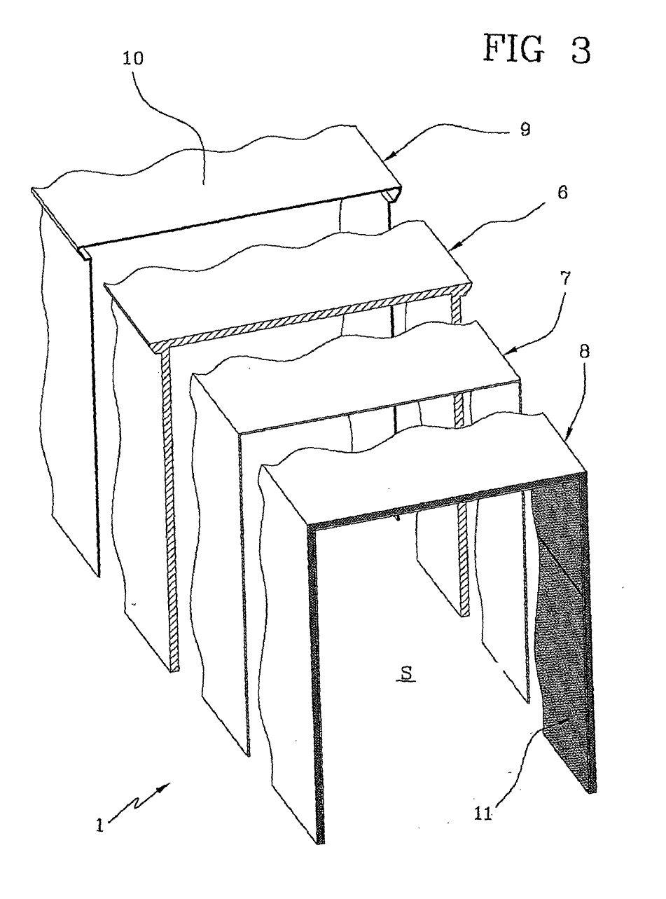

In accordance with the illustrated embodiment, the load-bearing structure 2 comprises a first layer 6 and a second layer 7, clearly shown in the exploded view of FIG. 3. The first layer 6 is in a more external position relative to the second layer 7, i.e. the two layers 6, 7 are arranged between them in such a way that the second layer 7 is oriented towards the aforementioned space “S”. Said two layers 6, 7 have different mechanical properties and present, in particular, different values of stiffness and of ability to absorb and dissipate energy in case of deformation. Preferably, the first layer 6 comprises one or more materials selected from the group comprising resin, aramid fibre and steel-reinforced polymers, to achieve a function of high mechanical strength, whilst the second layer 7 is made of one or more materials from the group comprising resin, aramid fibre and steel-reinforced polymers, to achieve a function of energy dissipation and absorption in case of deformation, hence a ballistic strength. The two layers 6, 7 thus exhibit different behaviours and therefore perform different functions with reference to a behaviour under load. In accordance with the preferred embodiment, the load-bearing 2 further comprises a third layer 8, adjacent to the second layer 7 and oriented towards the opposite side relative to the first layer 6, i.e. oriented towards the aforementioned space “S”. The third layer 8 comprises a material with long fibre, preferably obtained by means of a pultrusion process. The term “pultrusion” indicates a working process for plastic materials in which a bundle of filaments is impregnated with a resin and then made to harden obtaining a particularly strong and tough structure. Preferably, moreover, the load-bearing structure 2 comprises an outer layer 9, associated to the first layer 6 at the opposite side relative to the second layer 7 and defining an outer, visible surface 10 of the desk. The outer layer is obtained with a traditional material, and in particular one that is able to define a smooth washable surface. The aforementioned superposed layers 6, 7, 8, 9 have corresponding profiles substantially complementarily shaped with respect to each other to be correctly laid one over the other and mutually fastened in a stable manner to obtain the load-bearing structure, in accordance with the view of FIG. 3.

Advantageously, the desk comprises an elastic layer 11 which covers at least partially a surface of the load-bearing structure 2 and it is associated to the load-bearing structure 2 itself to obtain, in co-operation therewith, an absorption and/or a dissipation of energy as a result of deformations of the desk. In accordance with the views of FIGS. 1, 2, 3, 4, 5, the elastic layer 11 is superposed to an inner surface 13 of the load-bearing structure 2, i.e. superposed to the third layer 8 of the load-bearing structure 2 itself. The elastic layer 11 is made of polyurea, preferably by means of a method of directly spraying the polyurea itself on the aforementioned inner surface 12, and it is preferably superposed to the entire inner surface 12 of the load-bearing structure 2.

Advantageously, moreover, the elastic layer 11 is at least partially uncoupled from the inner surface 12, hence from the load-bearing structure 2, to enable a mutual sliding between the elastic layer 11 and the inner surface 12. To unable said uncoupling, the elastic layer 11 is coupled to the load-bearing structure 2 only at a discrete number of points, and in particular at least at a first pair of points. More in detail, said coupling takes place at two angular portions 13, 14 of the load-bearing structure 2 situated between the central portion 5 and the two lateral walls 3, 4. In the remaining parts of the inner surface 12 of the load-bearing structure 2 there is an intermediate layer 15, made of detaching material, which coats the aforesaid inner surface 12 and is interposed between the load-bearing structure 2 and the elastic layer 11 so that said layer is at least partly uncoupled from the load-bearing structure 2 and can be deformed and slide tangentially relative thereto by effect of the deformations undergone by the load-bearing structure 2 as a result, for example, of impulsive impacts against the desk. It should be specified that the term “detaching material”, or “removing material” means a material able to facilitate the mutual sliding between a pair of surfaces, preventing their cohesion and, within the scope of the present invention, the detaching material is preferably silicone surfactant, acrylic resin, polyvinyl butyrate or invisible adhesive, applied by spraying onto portions of the inner surface 12 before the application of the polyurea elastic layer 11.

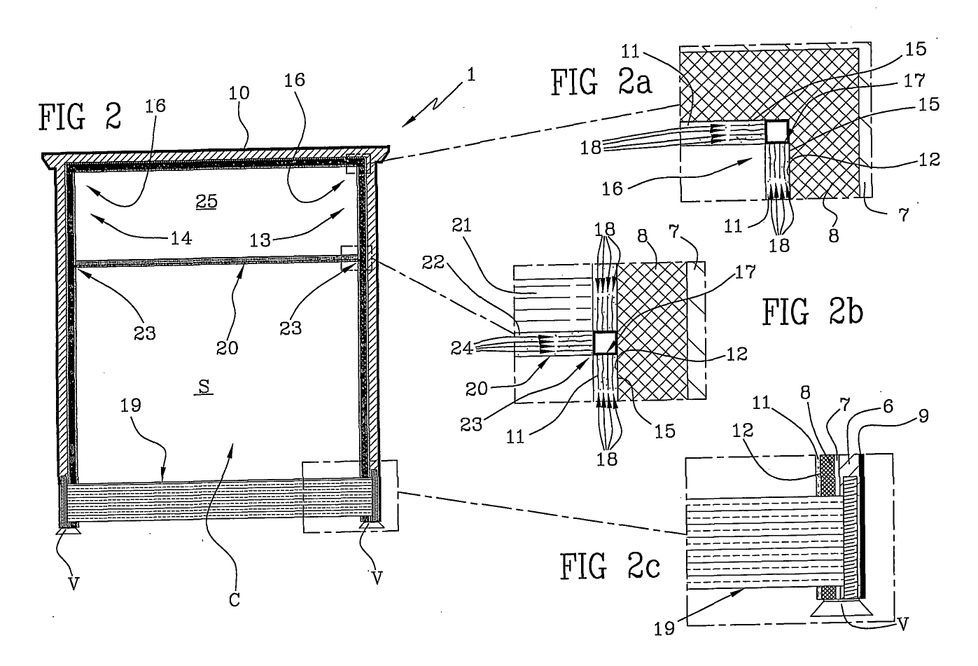

The coupling of the elastic layer 11 to the load-bearing structure 2 takes place by means of appropriate anchoring elements 16 stably associated to the load-bearing structure 2 and each of which positioned at the aforementioned attachment points, in accordance with the view of FIG. 2a.

Each anchoring element 16 comprises a support 17, associated to the load-bearing structure 2, and a plurality of filaments 18, preferably constituted by glass, aramid or carbon fibres, that extend away from the support 17 to engage the elastic layer 11 defining veritable grip means with respect to the elastic layer 11. More in detail, the filaments 18 are oriented along the inner surface 12 of the load-bearing structure 2 so that, when the polyurea is sprayed on said inner surface 12, the polyurea itself goes to encompass the filaments 18 so that, once the polyurea hardens, the filaments 18 remain irreversibly associated in a permanent manner to the elastic layer 11 obtained with the polyurea itself. More preferably, said filaments 18 constitute a spool of wires, partially buried within the support 18 and having a free external terminal portion which is able to be impregnated and anchored in the elastic layer 11. For this purpose, the filaments 17 are well distributed on one or more planes, parallel to the inner surface 12 of the load-bearing structure 2, e.g. constituting a 360° flower when seen in plan view.

According to a first embodiment, the anchoring elements 16 are obtained directly with the third layer 8 of the load-bearing structure 2, and in particular as an integrated projection of the third layer 8 through an increased thickness of the third layer 8 itself. In accordance with a second embodiment, the anchoring elements 16 are connected to the third layer 8 subsequently to the manufacture thereof, and said connection takes place by means of chemical/physical/mechanical coupling systems, preferably by gluing.

The load-bearing structure 2 can moreover advantageously comprise a closing element 19, stably connected to the lateral walls 3, 4 of the load-bearing structure 2, preferably in opposite position relative to the central portion 5 and still more preferably at end edges of the lateral walls 3, 4 opposite to the central portion 5, in accordance with the views of the accompanying figures. In this configuration, the closing element 19 defines a footrest for the user. The stable coupling between the closing element 19 and the lateral walls 3, 4 is accomplished by means of mechanical or chemical means, illustrated in FIG. 2c by a threaded coupling. Preferably, the closing element 19 is made of carbon fibre and obtained from a pultrusion process, and it is able to serve as a tie rod or a strut according to a type of collapse whereto the desk can be subjected under an external impacting action. Advantageously, moreover, the desk comprises a shelf 20 stably associated to the lateral walls 3, 4 and positioned inferiorly distanced from the central portion 5 of the load-bearing structure 2. Said shelf, which embodies for example a support for books, preferably comprises a main body 21, made with a material with long fibres, and it further comprises an elastic film 22, preferably made of polyurea. The shelf 20 is supported by auxiliary anchoring elements 23 similar to the anchoring elements 16 described above and also stably connected to the load-bearing structure 2 and in particular to the third layer 8. In this case, however, the elastic layer 11 would be connected to the third layer 8 at four points, i.e. at the angular portions 13, 14 and at the shelf 20, because the presence of the auxiliary anchoring elements 23 would interrupt a continuity of the elastic layer 11 along the lateral walls 3, 4. The auxiliary anchoring elements 23 also comprise one or more auxiliary filaments 24 which extend away from the inner surface 12, and perpendicularly thereto, to be impregnated with the elastic polyurea film of the shelf 20, as shown in FIG. 2b, embodying a support of the shelf 20. The auxiliary filaments 24 are also constituted by glass, aramid or carbon fibres.

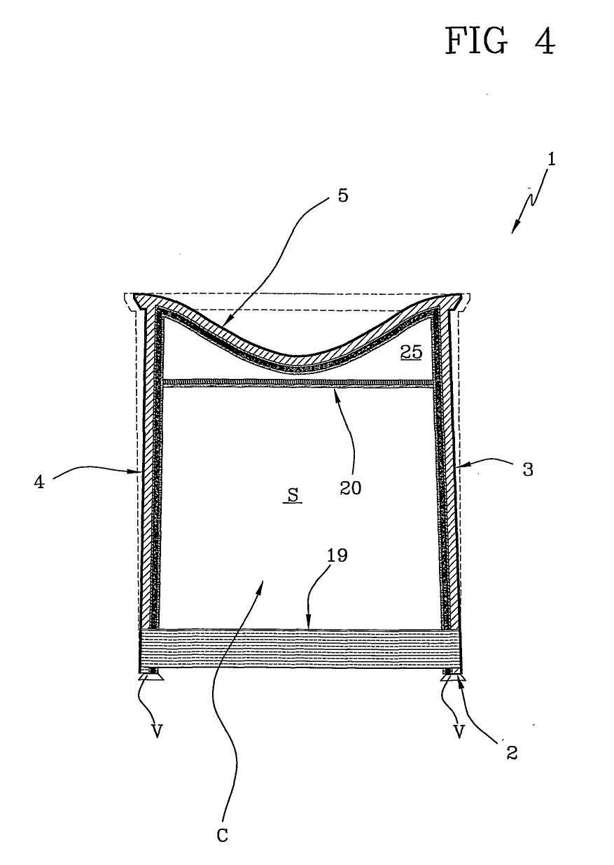

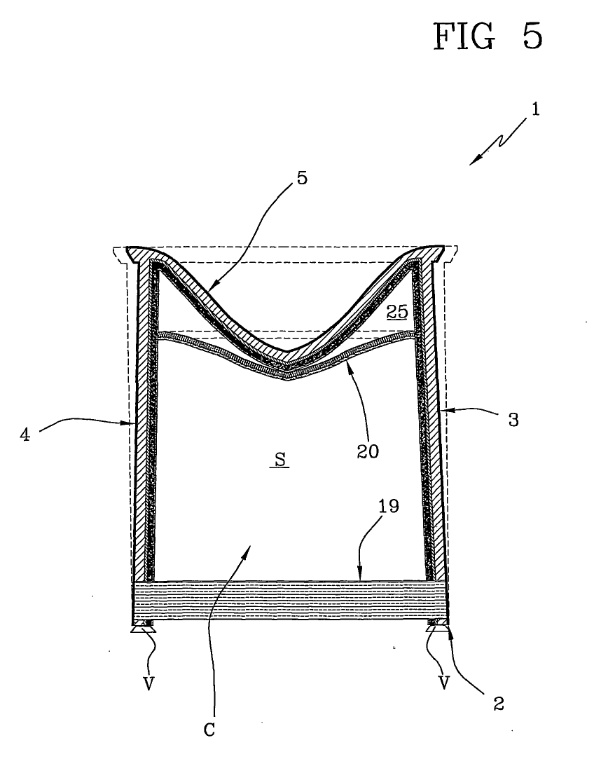

In this configuration, the shelf 21 is preferably parallel to the central portion 5 of the load-bearing structure 2, the shelf 20 defines an additional interposition element destined to repair the aforementioned pace “S”, which is below the shelf 20. Between the shelf 20 and the central portion 5 of the load-bearing structure 2, a compartment 25 is delimited, to contain books or other accessories, within which the central portion 5 itself can be deformed freely if the desk is hit violently from above (deformed position of FIG. 4, in which the non-deformed configuration of the desk is indicated with a dashed line). If the deformation of the central portion 5 is very marked, the deformation of the central portion 5 would extend to the point of interfering with the shelf 20, which would in turn be deformed, defining an additional obstacle to subsequent deformation (deformation position of FIG. 5, in which the non deformed configuration of the desk is indicated with a dashed line). In accordance with the conformation of the desk described above, it is readily apparent that the space “S” delimited by the load-bearing structure 2, and possibly by the closing element 19 positioned inferiorly, defines a protection cell “C” within which a user can find shelter against dangerous events, such as a fall of rubble and/or portions of a building within which the desk is situated. This is particularly advantageous in the case of seismic events, because each user would find shelter within the protection cell “C” embodied by his/her own desk. The presence of the closing element 19 generates an additional increase in overall strength of the desk, because it hinders (defining a tie rod) a typical collapse mode of the desk in which the legs of the desk tend to diverge and to lead to a crashing collapse in case of impacting load originating from above.

Advantageously, the load-bearing structure 2 is stably connectable to ground through connecting means, preferably reversible, which are active between the lateral walls 3, 4 and the ground to generate a dissipation of energy during a deformation of the furniture item 1 and to hinder the deformation of the furniture item 1. In particular, as shown in FIGS. 2, 4, 5 and in detail in FIG. 2a, the connecting means comprise a plurality of suction elements “V” which are stably connected to lower portions of the walls 3, 4 of the load-bearing structure 2, i.e. to their feet, and they are able to adhere to a bearing surface of the ground whereon the furniture item 1 bears. Preferably, moreover, both the lateral walls 3, 4 of the load-bearing structure 2 are equipped with the aforementioned suction cup elements “V”, and still more preferably the suction cup elements “V” are symmetrically arranged in pairs on both lateral walls 3, 4 to achieve a substantially identical anchoring effect on both lateral walls 3, 4. If the furniture item 1 is not a desk for school use, but generally another furniture item, a protection cell “C” of the type described above would be equally obtainable, by obtaining a space “S” preferably delimited by a closed profile and having such dimensions as to contain one or more persons and to embody a shelter for them in case of a hazardous event.

The present invention achieves the proposed objects, overcoming the drawings noted in the prior art.

The construction of a furniture item having a load-bearing structure provided with an elastic layer, and in particular a layer of polyurea, enables to withstand impacting loads even after a collapse of the load-bearing structure itself, thanks to the fact that the elastic layer can be deformed contributing to the strength of the furniture item even when the strength of the load-bearing structure fails, greatly reducing the risks of fragile breakage, i.e. crushing, of the furniture item. This is also aided by the possibility of mutual sliding between the elastic layer and the load-bearing structure, which frees the elastic layer from even large deformations of the load-bearing structure enabling the elastic layer to bring at each instant a contribution to the overall strength of the furniture item.

The strength of the load-bearing structure is also markedly improved thanks to its construction on different layers having different functions and to the use of materials with long fibres, which preferably extends along an entire development of the load-bearing structure. In particular, the first layer generates considerable mechanical strength, whilst the second layer thanks to the presence of aramid or steel fibres, impregnated with adequate matrices) provides an effective ballistic protection action and a considerable energy dissipation during an impact or a violent collision.

Moreover, the arrangement of the elastic layer on the inner surface of the load-bearing structure allows to isolate the protection cell from any splinters or sharp fragments generated as a result of ruptures and/or collapses of the load-bearing structure.

Additionally, the adoption of a closed profile delimiting the protection cell, in which the lateral walls of each layer are made in a single piece with the corresponding central portion, increases the strength of the load-bearing structure and hence the level of safety for the user who shelters therein.

In the case of a desk for school use, impact resistance is also extended to the lateral walls, which are closed and do not present any openings and therefore allow completely to delimit a protection cell for the user. Moreover, the level of safety attributed to the protection cell is increased by the presence of the book shelf, which constitutes an additional element interposed between an impacting action originating from above and the protection cell.

An additional contribution to the stability of the furniture item is given by the presence of the connecting means that generate an effect of anchoring the lower portions of the lateral walls to the ground. This enables in the first place to level the positioning of the furniture item and to maintain the furniture item in position so that it is not subject to undesired displacements (translations, upsets) when the user seeks shelter in the protection cell. In the second place, the presence of the aforementioned connecting means determines a dissipation of energy during the deformation of the load-bearing structure, in particular when the connecting means are in the form of a plurality of suction cup elements. Moreover, the connecting means stabilise the position of the lateral walls of the load-bearing structure, hindering the deformation thereof during an impact and in particular contributing to prevent the lateral walls from tending to collapse “diverging” under the action, for example, of an impact originating from above. In relation to the use of polyurea, among its advantages to be highlighted are its very short setting time (a few seconds for it to harden) and its ease of application, which can be accomplished by simple spraying.

1. Impact-resistant furniture item, comprising:
a load-bearing structure (2), having a support function for said furniture item (1);
an elastic layer (11), associated to said load-bearing structure (2) and co-operating therewith to achieve an absorption and/or a dissipation of energy following deformations of the furniture item (1); said elastic layer (11) being superposed to said load-bearing structure (2) and at least partially uncoupled therefrom so that said elastic layer (11) can be deformed and slide relative to the load-bearing structure (2).

2. Furniture item as claimed in claim 1, characterised in that said elastic layer (11) is made with polyurea, preferably by spraying.

3. Furniture item as claimed in claim 1, characterised in that said elastic layer (11) is stably associated to the load-bearing structure (2) exclusively at a plurality of points of said load-bearing structure (2).

4. Furniture item as claimed in claim 3, characterised in that it comprises a pair of anchoring elements (16), stably connected to the load-bearing structure (2) at said plurality of points and each of which presenting a plurality of filaments (18) arranged away from the respective anchoring element (16), said filaments (18) defining grip members active on said elastic layer (11) to maintain said elastic layer (11) stably connected to the load-bearing structure (2).

5. A furniture item as claimed in claim 1, characterised in that it comprises an intermediate layer (15) made of detaching material interposed between said load-bearing structure (2) and said elastic layer (11) to maintain the elastic layer (11) uncoupled from the load-bearing structure (2) at least according to a mutual sliding motion.

6. Furniture item as claimed in claim 1, characterised in that said load-bearing structure (2) comprises two lateral walls (3, 4) and a central portion (5) connected to the lateral portions (3, 4) to define, in mutual co-operation, a space (S) able to embody a protection cell (C) for a user, said lateral walls (3, 4) and said central portion (5) not presenting through openings and being made in a single piece with each other.

7. Furniture item as claimed in claim 6, characterised in that said elastic layer (11) is positioned on an inner surface (12) of the load-bearing structure (2) oriented towards said protection cell (C), at least to shelter said protection cell (C) against any bodies or fragments originating from an outside environment and moving towards said protection cell (C).

8. Furniture item as claimed in claim 6, characterised in that said elastic layer (11) is stably associated to the load-bearing structure (2) at angular portions (13, 14) thereof situated between the central portion (5) and the lateral walls (3, 4).

9. Furniture item as claimed in claim 1, characterised in that said load-bearing structure (2) is at least partially made of a material with long fibre, preferably by pultrusion.

10. Furniture item as claimed in claim 1, characterised in that the main structure (2) comprises a first layer (6) made of one or more materials selected from the group comprising resin, glass fibre and steel-reinforced polymers, to perform a function of high mechanical strength, and a second layer (7) made of one or more materials selected from the group comprising resin, aramid fibre and steel-reinforced polymers, to serve a function of energy dissipation and absorption in case of deformation of the load-bearing structure (2).

11. Furniture item as claimed in claim 6, characterised in that said load-bearing structure (2) comprises a closing element (19), able to be stably associated to said lateral walls (3, 4) to embody, in co-operation with the lateral walls (3, 4) and the central portion (5) of the load-bearing structure (2), a closed profile delimiting said protection cell (C).

12. Furniture item as claimed in claim 6, characterised in that it comprises a self (20), stably associated to said load-bearing structure (2) and distanced from said central portion (5) in the direction of said protection cell (C), said shelf (20) comprising at least one elastic film (22) made of polyurea in such a way as to define an additional element of interposition between said protection cell (C) and an external impacting action.

13. Furniture item as claimed in claim 1, characterised in that it comprises connecting means connected to the load-bearing structure (2) and stably connectable to the ground to maintain the load-bearing structure (2) in stably position relative to the ground at least during an impacting event against the furniture item (1).

14. Method for manufacturing a furniture item (1) as claimed in claim 1, comprising the steps of:—readying said load-bearing structure (2);
readying anchoring means (16) on a plurality of points of said load-bearing structure (2);
applying an elastic layer (11) of polyurea on at least one surface (12) of said load-bearing structure (2), preferably by spraying, so that the applied polyurea is laid also on said anchoring means (16) and remains stably connected to the load-bearing structure (2) by effect of said anchoring means (16).

15. Method as claimed in claim 14, characterised in that it comprises, before the step of applying the elastic polyurea layer (11), a step of applying an intermediate layer (15) of detaching material on portions of said surface (12) of the load-bearing structure (2) not involved by the anchoring means (16), to uncouple the intermediate layer (15) of polyurea from said surface (12) at said portions of the surface (12) not involved by the anchoring elements (16). 16.

16. Method as claimed in claim 14, characterised in that it comprises a step of applying to the load-bearing structure (2) reversible connecting means, stably connectable to a surface whereon the furniture item (1) is to bear, and able to maintain the furniture item in a stable position (1) relative to said surface.
